(19) United States
(12) Patent Application Publication
(10) Pub. No.: US 2019/0243437 A1
(43) Pub. Date: Aug. 8, 2019

(54) METHOD FOR ADJUSTING CPU PERFORMANCE MODE AND MOBILE DEVICE

(71) Applicant: JRD Communication Inc., Shenzhen City (CN)

(72) Inventor: Hengchang ZHAO, Shenzhen City (CN)

(73) Assignee: JRD Communication Inc., Shenzhen City (CN)

(21) Appl. No.: 16/341,910

(22) PCT Filed: Aug. 14, 2017
(86) PCT No.: PCT/CN2017/097381

§ 371 Date: Apr. 14, 2019

(30) Foreign Application Priority Data
Oct. 14, 2016 (CN) 201610899509.3

(51) Int. Cl. G06F 1/324; G06F 11/30; G06F 11/34; G06F 9/50

(52) U.S. Cl. CPC G06F 1/324; G06F 9/5044; G06F 11/3452; G06F 11/3024

(57) ABSTRACT

A method for adjusting a CPU performance mode, and a mobile device. The method comprises: collecting statistics about running data information of an application, and storing same into an application and running data information corresponding table, wherein each application in the application and running data information corresponding table corresponds to multiple pieces of running data information (S10); selecting an optimal CPU performance mode according to the application and running data information corresponding table (S11); updating an application and CPU performance mode corresponding table according to the optimal CPU performance mode, wherein each application in the application and CPU performance mode corresponding table corresponds to one CPU performance mode (S12).According to the method, a CPU performance mode can be adjusted according to a usage scenario, to provide users with smoother user experience while keeping the power consumption low.

### TECHNICAL FIELD OF THE INVENTION

The present invention relates to a communication field, and more particular to a method for adjusting a CPU performance mode and a mobile device.

### BACKGROUND OF THE INVENTION

The hardware performance of mobile device is now relatively higher. However, due to battery capacity limitations, devices cannot always remain in high-energy running mode. If wanting to get better standby and usage time, it needs to face the problem of achieving low power consumption while maintaining device performance. Therefore, many mobile devices have various performance modes for users to choose. In different modes, the Central Processing Unit (CPU) performance will be adjusted, such as screen brightness, vibration settings, sound settings and other different settings to achieve different user experience.

At present, the adjustment for the CPU performance mode is generally fixed, that is, no change after the user sets the CPU performance mode; for instance, after setting the CPU performance mode to balanced mode, the CPU performance mode is fixed in the balanced mode. For different applications, the CPU performance mode of the same application will not change under different loadings.

In practical, different applications have inconsistent CPU performance requirements, and ordinary applications do not require high CPU performance. When running the ordinary applications, configuring a low power mode can meet the needs of use while saving power. The same application may also have different CPU performance requirements due to different user usage. The CPU performance mode of the prior art cannot be dynamically adjusted according to a usage scenario of the user.

### SUMMARY OF THE INVENTION

The embodiment of the present invention provides a method for adjusting a CPU performance mode and a mobile device, which can adjust CPU performance mode according to a usage scenario, to provide users with smoother user experience while keeping the power consumption low.

The present invention provides a method for adjusting a CPU performance mode, including: collecting statistics about running data information of an application, and storing same into an application and running data information corresponding table, wherein each application in the application and running data information corresponding table corresponds to multiple pieces of running data information; selecting an optimal CPU performance mode according to the application and running data information corresponding table; updating an application and CPU performance mode corresponding table according to the optimal CPU performance mode, wherein each application in the application and CPU performance mode corresponding table corresponds to one CPU performance mode.

The method further includes: finding a CPU performance mode corresponding to the application from the application and CPU performance mode corresponding table, and running the application with the CPU performance mode that is found when the application is activated.

Before the step of collecting statistics about the running data information of the application, the method comprises: pre-establishing and saving an application and running data information corresponding table, wherein each application corresponds to several times of previously presetting running data information, and the running data information comprises: a CPU usage rate, a display frame number per second and an input response time; pre-establishing and saving an application and CPU performance mode corresponding table.

The CPU performance mode comprises at least one of a high performance mode, a balanced mode and a low power mode.

The step of updating the application and CPU performance mode corresponding table according to the optimal CPU performance mode comprises: keeping the application and CPU performance mode corresponding table unchanged if the optimal CPU performance mode already exists in the application and CPU performance mode corresponding table and corresponds to the application; updating the application and CPU performance mode corresponding table if the optimal CPU performance mode in the application and CPU performance mode corresponding table does not correspond to the application; adding an optimal CPU performance mode corresponding to the application if the optimal CPU performance mode corresponding to the application does not exist in the application and CPU performance mode corresponding table.

The present invention further provides mobile device for adjusting a CPU performance mode, including: a statistics collecting module, collecting statistics about running data information of an application, and storing same into an application and running data information corresponding table, wherein each application in the application and running data information corresponding table corresponds to multiple pieces of the running data information; a selecting module, coupled to the statistics collecting module for selecting an optimal CPU performance mode according to the application and running data information corresponding table; an updating module, coupled to the selecting module for updating the application and CPU performance mode corresponding table according to the optimal CPU performance mode.

The method further includes: finding a CPU performance mode corresponding to the application from the application and CPU performance mode corresponding table, and running the application with the CPU performance mode that is found when the application is activated.

Before the step of collecting statistics about the running data information of the application, the method comprises: pre-establishing and saving an application and running data information corresponding table, wherein each application corresponds to several times of previously presetting running data information, and the running data information comprises: a CPU usage rate, a display frame number per second and an input response time; pre-establishing and saving an application and CPU performance mode corresponding table.

The CPU performance mode comprises at least one of a high performance mode, a balanced mode and a low power mode.

The updating module is for keeping the application and CPU performance mode corresponding table unchanged if the optimal CPU performance mode already exists in the application and CPU performance mode corresponding table and corresponds to the application; updating the application and CPU performance mode corresponding table if the optimal CPU performance mode in the application and CPU performance mode corresponding table does not correspond to the application; adding an optimal CPU performance mode corresponding to the application if the optimal CPU performance mode corresponding to the application does not exist in the application and CPU performance mode corresponding table.

With the above schemes, the beneficial effects of the present invention are: the present invention implements collecting statistics about the running data information of the application, and storing the same into the application and running data information corresponding table, wherein each application in the application and running data information corresponding table corresponds to multiple pieces of running data information; selecting the optimal CPU performance mode according to the application and running data information corresponding table; updating the application and CPU performance mode corresponding table according to the optimal CPU performance mode, the CPU performance mode can be adjusted according to the usage scenario, to provide users with smoother user experience while keeping the power consumption low.

### BRIEF DESCRIPTION OF THE DRAWINGS

FIG. 1 is a flow chart of a method for adjusting a CPU performance mode according to an embodiment of the present invention;

FIG. 2 is a structural diagram of an electronic device for adjusting a CPU performance mode according to the first embodiment of the present invention;

FIG. 3 is a structural diagram of an electronic device for adjusting a CPU performance mode according to the second embodiment of the present invention;

FIG. 4 is a structural diagram of a physical device of an electronic device for adjusting a CPU performance mode according to the embodiment of the present invention.

### DETAILED DESCRIPTION OF THE INVENTION

Embodiments of the present invention are described in detail with the technical matters, structural features, achieved objects, and effects with reference to the accompanying drawings as follows. It is clear that the described embodiments are merely part of embodiments of the present invention, but not all embodiments.

Based on the embodiments of the present invention, all other embodiments to those of ordinary skill in the premise of no creative efforts obtained, should be considered within the scope of protection of the present invention.

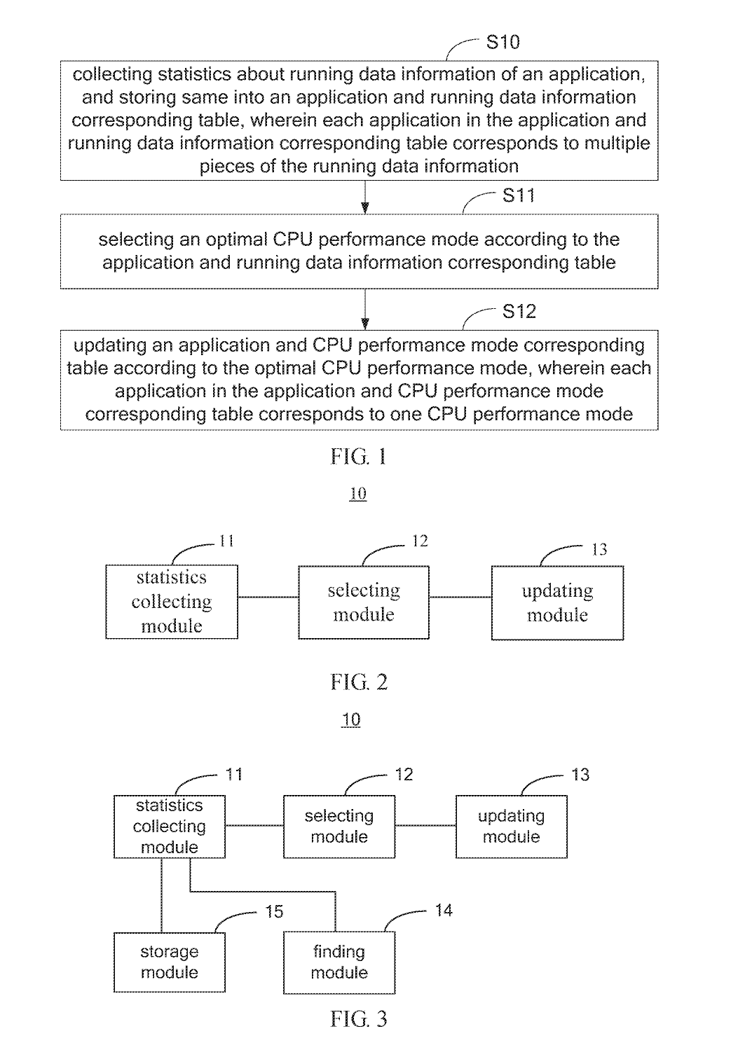

FIG. 1 is a flow chart of a method for adjusting a CPU performance mode according to an embodiment of the present invention. As shown in FIG. 1, the method for adjusting the CPU performance mode includes:

Step S10: collecting statistics about running data information of an application, and storing same into an application and running data information corresponding table, wherein each application in the application and running data information corresponding table corresponds to multiple pieces of the running data information.

In the embodiment of the present invention, the method includes finding a CPU performance mode corresponding to the application from the application and CPU performance mode corresponding table, and running the application with the CPU performance mode that is found when the application is activated. The application is run with a default CPU performance mode if a CPU performance mode corresponding to the application is not found in the application and CPU performance mode corresponding table. The CPU performance mode comprises at least one of a high performance mode, a balanced mode and a low power mode.

Before Step S10, the method includes pre-establishing and saving an application and running data information corresponding table, wherein each application corresponds to several times of previously presetting running data information, and also includes pre-establishing and saving an application and CPU performance mode corresponding table. The running data information includes but is not limited to: a CPU usage rate, a display frame number per second (frames per second, FPS) and an input response time. The number of the times of previously presetting can be set according to the requirement, and preferably to be three times.

Step S11, selecting an optimal CPU performance mode according to the application and running data information corresponding table.

In the embodiment of the present invention, in Step S11, the multiple pieces of the running data information corresponding to the application are evaluated in the application and running data information corresponding table to obtain an optimal CPU performance mode of the application.

Step S12, updating an application and CPU performance mode corresponding table according to the optimal CPU performance mode, wherein each application in the application and CPU performance mode corresponding table corresponds to one CPU performance mode.

In Step S12, updating the application and CPU performance mode corresponding table according to the optimal CPU performance mode includes:

keeping the application and CPU performance mode corresponding table unchanged if the optimal CPU performance mode already exists in the application and CPU performance mode corresponding table and corresponds to the application; updating the application and CPU performance mode corresponding table if the optimal CPU performance mode in the application and CPU performance mode corresponding table does not correspond to the application; adding an optimal CPU performance mode corresponding to the application if the optimal CPU performance mode corresponding to the application does not exist in the application and CPU performance mode corresponding table. Accordingly, when the application activated next time, it can be run with the best CPU performance mode by finding the application and CPU performance mode corresponding table, which can adjust CPU performance mode according to a usage scenario, to provide users with smoother user experience while keeping the power consumption low.

FIG. 2 is a structural diagram of an electronic device for adjusting a CPU performance mode according to the first embodiment of the present invention. As shown in FIG. 2, the electronic device 10 for adjusting a CPU performance mode includes: a statistics collecting module 11, a selecting module 12 and an updating module 13. The statistics collecting module 11 is configured for collecting statistics about the running data information of the application, and storing the same into an application and running data information corresponding table. Each application in the application and running data information corresponding table corresponds to multiple pieces of running data information. The selecting module 12 is coupled to the statistics collecting module 11 for selecting an optimal CPU performance mode according to the application and running data information corresponding table. The updating module 13 is coupled to the selecting module 12 for updating the application and CPU performance mode corresponding table according the optimal CPU performance mode.

Please refer to FIG. 3. The mobile device 10 further includes a finding module 14, coupled to the statistics collecting module 11 for: finding a CPU performance mode corresponding to the application from the application and CPU performance mode corresponding table, and running the application with the CPU performance mode that is found when the application is activated. The application is run with a default CPU performance mode if a CPU performance mode corresponding to the application is not found in the application and CPU performance mode corresponding table. The CPU performance mode comprises at least one of a high performance mode, a balanced mode and a low power mode.

Please still refer to FIG. 3. The mobile device 10 further includes a storage module 15, coupled to the statistics collecting module 11 for: pre-establishing and saving an application and running data information corresponding table, wherein each application corresponds to several times of previously presetting running data information, and also includes pre-establishing and saving an application and CPU performance mode corresponding table. The running data information includes but is not limited to: a CPU usage rate, a display frame number per second and an input response time. The number of the times of previously presetting can be set according to the requirement, and preferably to be three times.

In the embodiment of the present invention, the updating module 13 is for keeping the application and CPU performance mode corresponding table unchanged if the optimal CPU performance mode already exists in the application and CPU performance mode corresponding table and corresponds to the application; updating the application and CPU performance mode corresponding table if the optimal CPU performance mode in the application and CPU performance mode corresponding table does not correspond to the application; adding an optimal CPU performance mode corresponding to the application if the optimal CPU performance mode corresponding to the application does not exist in the application and CPU performance mode corresponding table. Accordingly, when the application activated next time, it can be run with the best CPU performance mode by finding the application and CPU performance mode corresponding table, which can adjust CPU performance mode according to a usage scenario, to provide users with smoother user experience while keeping the power consumption low.

In the embodiment of the present invention, the electronic device 10 for adjusting the CPU performance mode may be a mobile communication electronic device, such as a mobile phone, an IPAD or a notebook, which is not limited herein.

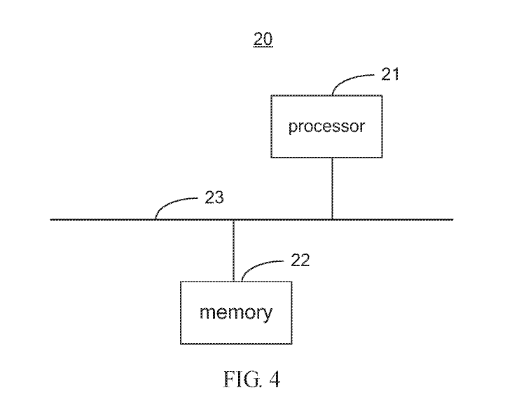

FIG. 4 is a structural diagram of a physical device of an electronic device for adjusting a CPU performance mode according to the embodiment of the present invention. As shown in FIG. 4, the electronic device 20 for adjusting a CPU performance mode includes: a processor 21, a memory 22 and a data bus 23. The processor 21 and the memory 22 are coupled via the data bus 23 for mutual communication.

The memory 22 stores a program, and the processor 21 is configured to execute the program.

The program is configured for:

collecting statistics about the running data information of an application, and storing the same into an application and running data information corresponding table;

selecting an optimal CPU performance mode according to the application and running data information corresponding table;

updating the application and CPU performance mode corresponding table according the optimal CPU performance mode.

Each application in the application and running data information corresponding table corresponds to multiple pieces of running data information.

The program is further configured for: finding a CPU performance mode corresponding to the application from the application and CPU performance mode corresponding table, and running the application with the CPU performance mode that is found when the application is activated. The application is run with a default CPU performance mode if a CPU performance mode corresponding to the application is not found in the application and CPU performance mode corresponding table. The CPU performance mode comprises at least one of a high performance mode, a balanced mode and a low power mode.

In the embodiment of the present invention, the memory 22 is further configured for pre-establishing and saving an application and running data information corresponding table, wherein each application corresponds to several times of previously presetting running data information, and also for pre-establishing and saving an application and CPU performance mode corresponding table. The running data information includes but is not limited to: a CPU usage rate, a display frame number per second and an input response time. The number of the times of previously presetting can be set according to the requirement, and preferably to be three times.

In the embodiment of the present invention, the program is further configured for keeping the application and CPU performance mode corresponding table unchanged if the optimal CPU performance mode already exists in the application and CPU performance mode corresponding table and corresponds to the application; updating the application and CPU performance mode corresponding table if the optimal CPU performance mode in the application and CPU performance mode corresponding table does not correspond to the application; adding an optimal CPU performance mode corresponding to the application if the optimal CPU performance mode corresponding to the application does not exist in the application and CPU performance mode corresponding table. Accordingly, when the application activated next time, it can be run with the best CPU performance mode by finding the application and CPU performance mode corresponding table, which can adjust CPU performance mode according to a usage scenario, to provide users with smoother user experience while keeping the power consumption low.

In conclusion, the present invention implements collecting statistics about the running data information of the application, and storing the same into the application and running data information corresponding table, wherein each application in the application and running data information corresponding table corresponds to multiple pieces of running data information; selecting the optimal CPU performance mode according to the application and running data information corresponding table; updating the application and CPU performance mode corresponding table according to the optimal CPU performance mode, the CPU performance mode can be adjusted according to the usage scenario, to provide users with smoother user experience while keeping the power consumption low.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

1. A method for adjusting a CPU performance mode, comprising:
pre-establishing and saving an application and running data information corresponding table, wherein each application corresponds to several times of previously presetting running data information, and the running data information comprises: a CPU usage rate, a display frame number per second and an input response time;
pre-establishing and saving an application and CPU performance mode corresponding table;
finding a CPU performance mode corresponding to the application from the application and CPU performance mode corresponding table, and running the application with the CPU performance mode that is found;
collecting statistics about running data information of an application, and storing same into an application and running data information corresponding table, wherein each application in the application and running data information corresponding table corresponds to multiple pieces of the running data information;
selecting an optimal CPU performance mode according to the application and running data information corresponding table;
updating the application and CPU performance mode corresponding table according to the optimal CPU performance mode, wherein each application in the application and CPU performance mode corresponding table corresponds to one CPU performance mode.

2. The method according to claim 1, wherein the CPU performance mode comprises at least one of a high performance mode, a balanced mode and a low power mode.

3. The method according to claim 1, wherein the step of updating the application and CPU performance mode corresponding table according to the optimal CPU performance mode comprises:
keeping the application and CPU performance mode corresponding table unchanged if the optimal CPU performance mode already exists in the application and CPU performance mode corresponding table and corresponds to the application;
updating the application and CPU performance mode corresponding table if the optimal CPU performance mode in the application and CPU performance mode corresponding table does not correspond to the application;
adding an optimal CPU performance mode corresponding to the application if the optimal CPU performance mode corresponding to the application does not exist in the application and CPU performance mode corresponding table.

4. A method for adjusting a CPU performance mode, comprising:
collecting statistics about running data information of an application, and storing same into an application and running data information corresponding table, wherein each application in the application and running data information corresponding table corresponds to multiple pieces of the running data information;
selecting an optimal CPU performance mode according to the application and running data information corresponding table;
updating the application and CPU performance mode corresponding table according to the optimal CPU performance mode, wherein each application in the application and CPU performance mode corresponding table corresponds to one CPU performance mode.

5. The method according to claim 4, further comprising:
finding a CPU performance mode corresponding to the application from the application and CPU performance mode corresponding table, and running the application with the CPU performance mode that is found when the application is activated.

6. The method according to claim 4, wherein before the step of collecting statistics about the running data information of the application, the method comprises:
pre-establishing and saving the application and running data information corresponding table, wherein each application corresponds to several times of previously presetting running data information, and the running data information comprises: a CPU usage rate, a display frame number per second and an input response time;
pre-establishing and saving an application and CPU performance mode corresponding table.

7. The method according to claim 4, wherein the CPU performance mode comprises at least one of a high performance mode, a balanced mode and a low power mode.

8. The method according to claim 4, wherein the step of updating the application and CPU performance mode corresponding table according to the optimal CPU performance mode comprises:
keeping the application and CPU performance mode corresponding table unchanged if the optimal CPU performance mode already exists in the application and CPU performance mode corresponding table and corresponds to the application;
updating the application and CPU performance mode corresponding table if the optimal CPU performance mode in the application and CPU performance mode corresponding table does not correspond to the application;
adding an optimal CPU performance mode corresponding to the application if the optimal CPU performance mode corresponding to the application does not exist in the application and CPU performance mode corresponding table.

9. A mobile device for adjusting a CPU performance mode, comprising:
a processor;
a memory connected with processor, the memory comprising a plurality of program instructions executable by the processor, the plurality of program instructions comprising:
a statistics collecting module, collecting statistics about running data information of an application, and storing same into an application and running data information corresponding table, wherein each application in the application and running data information corresponding table corresponds to multiple pieces of the running data information;
a selecting module, coupled to the statistics collecting module for selecting an optimal CPU performance mode according to the application and running data information corresponding table;
an updating module, coupled to the selecting module for updating the application and CPU performance mode corresponding table according to the optimal CPU performance mode.

10. The mobile device according to claim 9, further comprising a finding module, coupled to the statistics collecting module for:
finding a CPU performance mode corresponding to the application from the application and CPU performance mode corresponding table, and running the application with the CPU performance mode that is found when the application is activated.

11. The mobile device according to claim 9, further comprising a storage module, coupled to the statistics collecting module for:
pre-establishing and saving the application and running data information corresponding table, wherein each application corresponds to several times of previously presetting running data information, and the running data information comprises: a CPU usage rate, a display frame number per second and an input response time;
pre-establishing and saving an application and CPU performance mode corresponding table.

12. The mobile device according to claim 9, wherein the CPU performance mode comprises at least one of a high performance mode, a balanced mode and a low power mode.

13. The mobile device according to claim 9, wherein the updating module is for:
keeping the application and CPU performance mode corresponding table unchanged if the optimal CPU performance mode already exists in the application and CPU performance mode corresponding table and corresponds to the application;
updating the application and CPU performance mode corresponding table if the optimal CPU performance mode in the application and CPU performance mode corresponding table does not correspond to the application;
adding an optimal CPU performance mode corresponding to the application if the optimal CPU performance mode corresponding to the application does not exist in the application and CPU performance mode corresponding table.
